(19) United States
(12) Patent Application Publication
(10) Pub. No.: US 2017/0185657 A1
(43) Pub. Date: Jun. 29, 2017

(54) SPHERE-LIKE MOBILE INTERACTIVE USER INTERFACE

(71) Applicant: THOMSON LICENSING, Issy les Moulineaux (FR)

(72) Inventor: Regine Jeanne SYDA-LAWTON, Newhall, CA (US)

(21) Appl. No.: 15/128,357

(22) PCT Filed: Mar. 19, 2015
(86) PCT No.: PCT/US15/21521

§ 371 Date: Sep. 22, 2016

Related U.S. Application Data
(60) Provisional application No. 61/970,939, filed on Mar. 27, 2014.

(51) Int. Cl. G06F 17/30

(52) U.S. Cl. CPC G06F 17/30554; G06F 3/04883

(57) ABSTRACT

A method and apparatus for generating a sphere-like mobile user interface is described including receiving search terms and search results, generating a sphere and blobs of the sphere and expanding a touched or swiped blob of the sphere.

### FIELD OF THE INVENTION

The present invention relates to mobile user interfaces and, in particular, to a sphere-like user interface in order to facilitate the engagement of users.

### BACKGROUND OF THE INVENTION

It is believed that the use of a sphere or globe-like user interface has not been used in the world wide web for searching and surfing, for any type of users (mobile or desktop). The present invention offers the users the ability to continuously motion across the screen for a complete worldwide view of the search results or web sites versus having to scroll down or up for hundreds of pages. This gives the user the ability within one swipe to see the world of his/her interest.

People may have displayed websites on a round object as shown in FIG. 2. The present invention is taking a flat website, and turning it into a sphere on a flat panel such as a tablet or phone for best experience, but can also be used on desktop machines as well.

### SUMMARY OF THE INVENTION

Using the concept of Google Earth on mobile devices, phones, tablets, etc . . . and the attractive nature of the iPad's touch enabled screen, being able to read, search, and view web content in a more fun and interactive way would increase data consumption, and keep users interacting with devices longer and more often.

The new UI interactive model of the present invention is based on a sphere or globe like platform, divided into multiple sections based on metadata about the topic, and like a roller ball, is touch sensitive, so as the user pushes on one area, or swipes to the right, the user moves into another area of the “globe”. The user views things (objects, data, information, content) globally, and, thus, the present invention turns mobile UI into a more touch sensitive and interactive view.

Today's long web pages, with vertical scrolling through lots of pages, and clicking through to endless URLs is not consumer friendly. The user does not have any idea of where he or she is going on the page, the user is just clicking blindly deeper and deeper like Alice jumping down the rabbit hole.

A method and apparatus for generating a sphere-like mobile user interface is described including receiving search terms and search results, generating a sphere and blobs of the sphere and expanding a touched or swiped blob of the sphere.

### BRIEF DESCRIPTION OF THE DRAWINGS

The present invention is best understood from the following detailed description when read in conjunction with the accompanying drawings. The drawings include the following figures briefly described below:

FIG. 1 is an example of a sphere-like mobile user interface of the present invention.

FIG. 2 is a rendering of a Google Earth display.

FIG. 3 shows various spheres for user interfaces.

FIG. 4A is a flowchart of an exemplary embodiment of the method to generate the sphere-like mobile user interface of the present invention.

FIG. 4B is a flowchart of the portion of FIG. 4A devoted to the generation of the sections (blobs) of the present invention.

FIG. 5 is a block diagram of a consumer device with display.

### DETAILED DESCRIPTION OF THE PREFERRED EMBODIMENTS

More and more people (users) enjoy touch interaction with iPads and other mobile devices as opposed to the old click and open URLs and static vertical pages. People (users) want to feel that they interact directly with the data, and the device makes it “enjoyable” through a play-like feel or game-like feel, and as games are very addictive, people may spend more time on the devices, and in the applications themselves. Since the world is moving away from solutions, this is a way to get more work or fun done on primarily mobile devices. The present invention is directed to consumer devices having displays such as mobile phones, tablets, iPhones, iPads, iPods, laptops, notebook computers and the like.

For Developers, being able to create ONE web site, that can be done the traditional way (today's URLs) and also compiled with the sphere-like library, they create a website ONCE and create both the standard desktop user interface and the new sphere-like mobile user interface of the present invention.

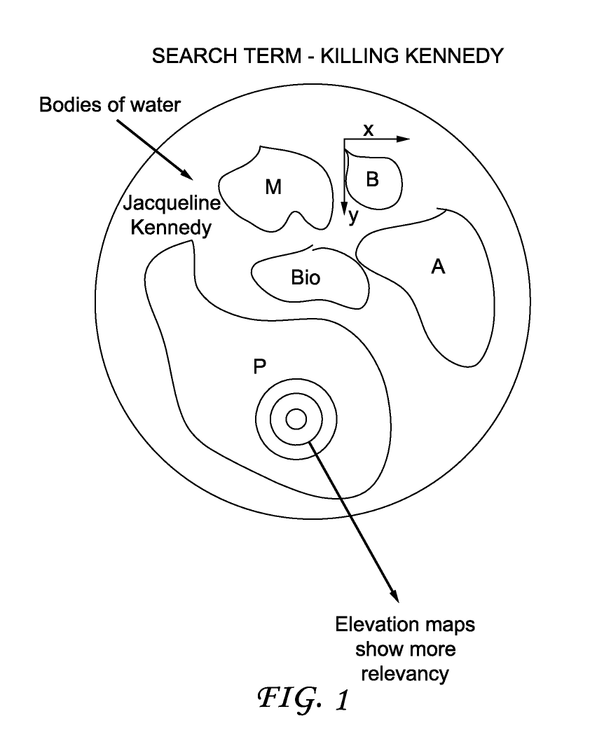

Three application use cases:
New search application which displays search results in a sphere-like view and shows you the relevancy amongst results (close vs. far), 15 top results, vs. 100 lower results
Entertainment application—search on any content category, the new sphere-like mobile interface will display metadata about the content category in a circular fashion (see FIG. 1) breaking it up into sections such as biography, characters, movie, press documentation, history of presidents, etc . . .
Medical application—anything the user wants to access about his/her health (all the user's records for all the user's doctors, hospital stays, lab results, etc . . . )

Two Business-To-Business Cases
Include this in mobile phones as part of their operating system, so the user has an option to view any web sites in the new sphere-like interactive model
Offer a software development kit (SDK) for mobile application developers to include this library into their own application.

In the sphere-like mobile user interface of the present invention:
1. There will be no pre-determined sections on the globe.
2. Sections will be created on the fly based on the search term, if a search, or a URL is given a website to visit.
3. For search term:
   a. The sections will be determined by the “name” of the search term, then by the number of hits, and then by their relevancy to the search term.
   b. The sections will be asymmetrical blobs, just like countries or continents on a map.
   c. The size of the blobs is based on popularity (number of hits), or relevancy, or relevancy to the search provider.
   d. The blob will be drawn based on X,Y fractals (taking a circle and stretching it into a blob based on these fractals)
   e. Sections that are in between the countries, ie: bodies of water, would be “Alternate Related” terms, such as Jacqueline Kennedy, JFK Jr, etc. on FIG. 1.
   f. For the relevancy, peaks of terrains can be shown (depicted), showing a higher elevation as being more relevant, similar to geographical or topological maps.
4. Each section, once touched, or swiped, will become primary, and display in larger view the items to be viewed/read.
5. The benefit of this approach is that the user can see the whole world of that section/category, in one swoop, without having to dig into each link. The user can then select what he/she wants to delve into or read.
6. The user can see the world of the “data object” that he/she is researching, in one swoop, and then get into more details.
7. Data or a web pages are already broken up into sections, by names usually, that can be used to determine (calculate) the blobs.
8. The web page is now circular, and all its beginnings and ends are visible with one swipe around the globe.

### Example 1: (See FIG. 1)

Search for “Killing Kennedy”.

Results (represented by countries on the sphere):
Books—5 hits (as shown by “B” on the diagram)
Movies—42 hits (as shown by “M” on the diagram)
Biography—10 hits (as shown by “Bio” on the diagram)
Assassination—1000 hits (as shown by “A” on the diagram)
Presidents—50000 hits (as shown by “P” on the diagram)

### Example 2

Type a URL like: www.macys.com or www.overstock.com or www.bedbathandbeyond.com

### Results:

The user will see sections being created for the following categories, determined by their nomenclatures:

For the home

Bed & Bath

Women

Men

Juniors

Kids

Beauty

Similar to example 1, these categories would appear as the “countries” on the sphere, and advertisements (ads) for “Free shipping” and other offers would appear in the “bodies of water”.

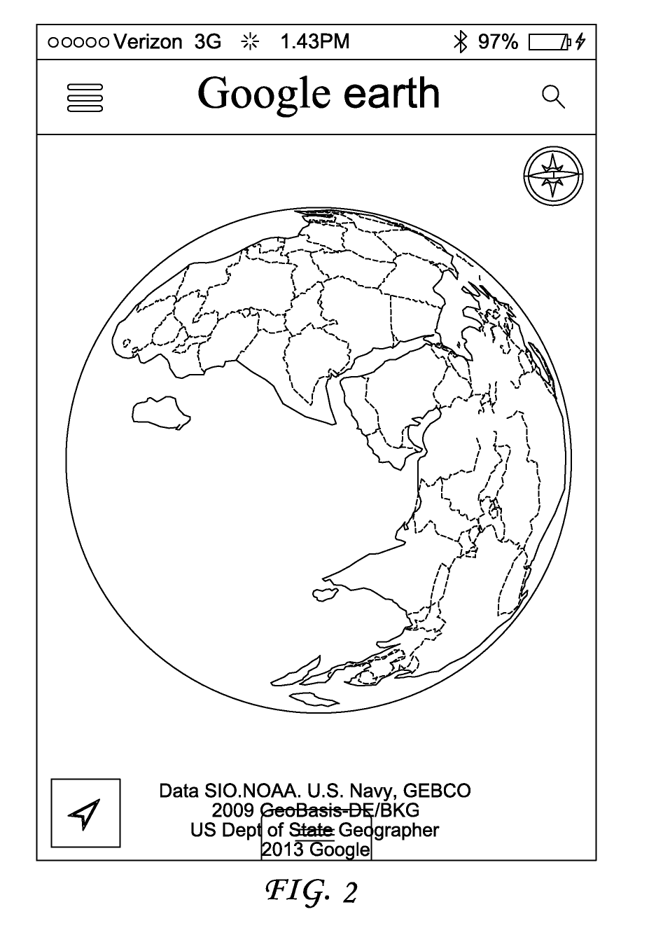

FIG. 2 is a rendering of a Google Earth display.

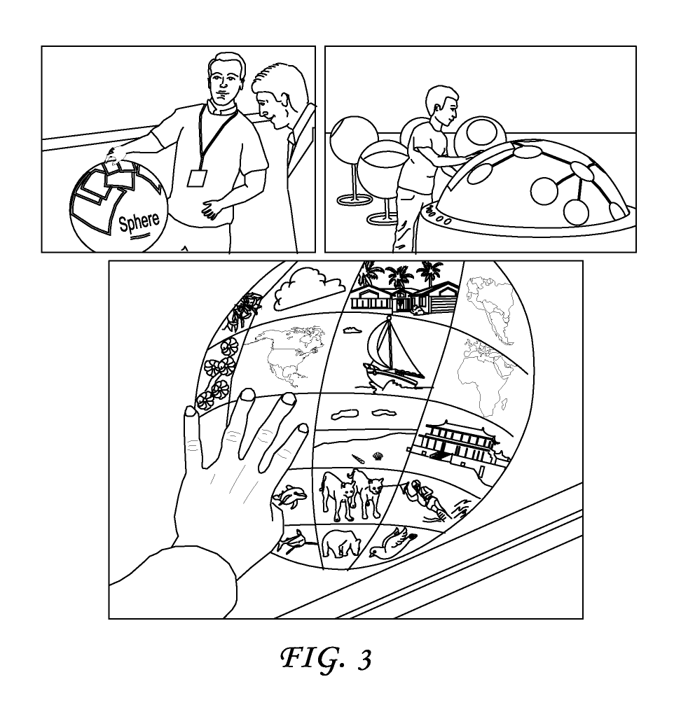

FIG. 3 shows various spheres for user interfaces.

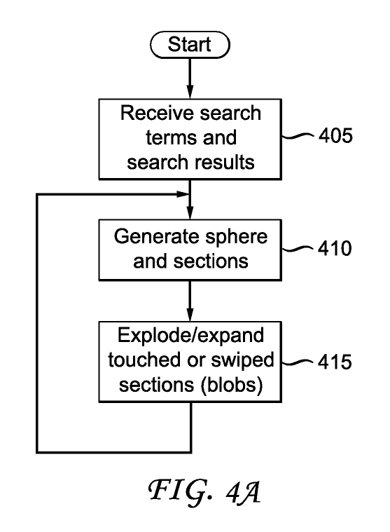

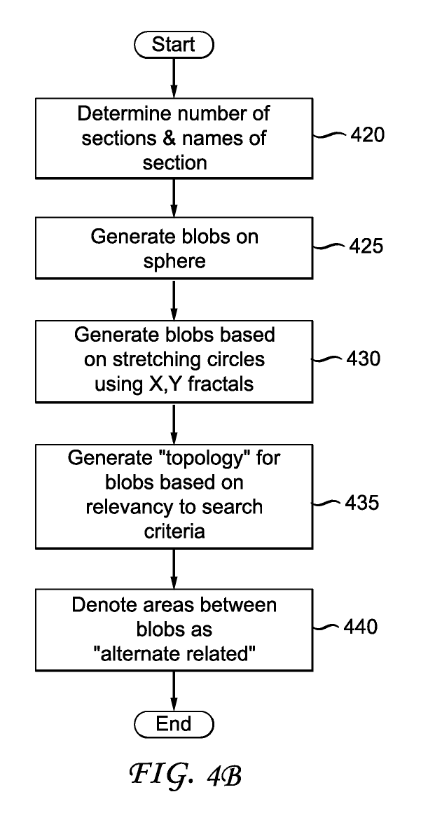

FIG. 4A is a flowchart of an exemplary embodiment of the method to generate the sphere-like mobile user interface of the present invention. At 405 the mobile the mobile device receives the search terms and search results. At 410 the mobile device generates a sphere and sections (blobs and inter-blob areas). At 415 the mobile device explodes or expands the touched or swiped areas (sections, blobs).

FIG. 4B is a flowchart of the portion of FIG. 4A devoted to the generation of the sections (blobs) of the present invention. At 420 the mobile device determines the number of sections (areas, blobs) and banes of the areas (blobs, sections). At 425 the mobile device generates the blobs (areas, sections) on the sphere. This is accomplished by starting with a number of circles equal to the number of blobs (areas, sections). At 430 the mobile device generates the blobs as they will be displayed based on stretching circles using X,Y fractals. At 435, any blobs that need “topology” are generated (created) based on relevancy to search criteria. At 440 the mobile device denotes the areas between blobs (inter-blob areas) as “alternate related”.

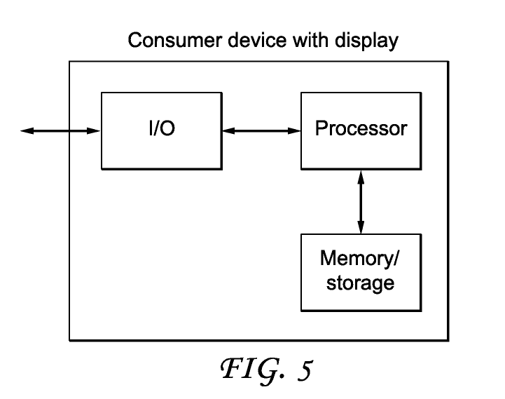

FIG. 5 is a block diagram of a consumer device with display. A consumer device with display includes devices such as mobile phones, tablets, iPhones, iPads, iPods, laptops, notebook computers and the like. There is typically a input/output (I/O) module, a processor and memory (storage). The I/O module would receive the search terms (search query) and forward this to the processor. The processor would perform the steps (acts) shown in FIGS. 4A and 4B as well as all other functions typical of a mobile consumer device with display. The processor uses memory to store the search terms, search criteria, search results and any intermediate results (calculations) used in the generation and display of the sphere-like mobile user interface of the present invention.

The mobile device receives search terms and search results via the I/O module. The processor of the mobile device generates a sphere and blobs of the sphere and expands a touched or swiped blob of the sphere. The processor of the mobile device determines a number of blobs and names of the determined blobs and generates blobs on the sphere, wherein the blobs start as circles. The processor of the mobile device generates the blobs based on stretching the circles using X,Y fractals and denotes areas between the blobs as alternate related content. The processor of the mobile device generates a topology for the blobs based on relevancy to the search terms.

It is to be understood that the present invention may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for generating a topological user interface for a mobile device, said method comprising;
receiving search terms and search results;
generating a sphere and asymmetrical areas of said sphere responsive to said search terms and said search results; and
expanding a touched or swiped asymmetrical areas of said sphere.

2. The method according to claim 1, wherein said generating step further comprises:
determining a number of asymmetrical areas and names of said determined asymmetrical areas;
generating asymmetrical areas on said sphere, wherein said start as circles;
generating said asymmetrical areas based on stretching said circles using X,Y fractals; and
denoting areas between said asymmetrical areas as alternate related content.

3. The method according to claim 2, further comprising generating a topology for said asymmetrical areas based on relevancy to said search terms.

4. A mobile device for generating a topological mobile user interface, comprising;
means for receiving search terms and search results;
means for generating a sphere and blobs of said sphere responsive to said search terms and said search results; and
means for expanding a touched or swiped asymmetrical areas of said sphere.

5. The mobile device according to claim 4, wherein said means for generating further comprises:
means for determining a number of asymmetrical areas and names of said determined asymmetrical areas;
means for generating asymmetrical areas on said sphere, wherein said asymmetrical areas start as circles;
means for generating said asymmetrical areas based on stretching said circles using X,Y fractals; and
means for denoting areas between said asymmetrical areas as alternate related content.

6. The mobile device according to claim 5, further comprising means for generating a topology for said asymmetrical areas based on relevancy to said search terms.

7. A mobile device for generating a topological mobile user interface, comprising;
an I/O module, said I/O module receiving search terms and search results;
a processor, said processor generating a sphere and asymmetrical areas of said sphere_responsive to said search terms and said search results, said processor in bi-directional communication with said I/O module; and
said processor expanding a touched or swiped asymmetrical areas_of said sphere.

8. The mobile device according to claim 7, wherein said means for generating further comprises:
said processor determining a number of asymmetrical areas and names of said determined asymmetrical areas;
said processor generating asymmetrical areas on said sphere, wherein said asymmetrical areas start as circles;
said processor generating said asymmetrical areas based on stretching said circles using X,Y fractals; and
said processor denoting areas between said asymmetrical areas as alternate related content.

9. The mobile device according to claim 8, further comprising said processor generating a topology for said asymmetrical areas based on relevancy to said search terms.
